(19) United States
(12) Patent Application Publication
(10) Pub. No.: US 2022/0310320 A1
(43) Pub. Date: Sep. 29, 2022

(54) METHOD FOR MANUFACTURING MULTILAYER COIL COMPONENT AND MULTILAYER COIL COMPONENT

(71) Applicant: TDK CORPORATION, Tokyo (JP)

(72) Inventors: Noriaki HAMACHI, Tokyo (JP); Toshinori MATSUURA, Tokyo (JP); Junichiro URABE, Tokyo (JP); Kazuya TOBITA, Tokyo (JP); Yuto SHIGA, Tokyo (JP); Youichi KAZUTA, Tokyo (JP); Yuichi TAKUBO, Tokyo (JP)

(73) Assignee: TDK CORPORATION, Tokyo (JP)

(21) Appl. No.: 17/694,999

(22) Filed: Mar. 15, 2022

(30) Foreign Application Priority Data
Mar. 26, 2021 (JP) 2021-053720

(51) Int. Cl. H01F 41/04; H01F 41/10; H01F 27/28; H01F 27/29

(52) U.S. Cl. CPC H01F 41/041; H01F 41/10; H01F 27/2804; H01F 27/292; H01F 2027/2809

(57) ABSTRACT

A method for manufacturing a multilayer coil component 1 includes: a step of forming an insulator layer 10; a step of forming a first coil conductor 20, a second coil conductor 21, a third coil conductor 22, and a fourth coil conductor 23; a step of obtaining a laminate L formed by laminating the insulator layer 10, the first coil conductor 20, the second coil conductor 21, the third coil conductor 22, and the fourth coil conductor 23; and a step of forming terminal electrodes 4 and 5 on the outer surface of the laminate L by a photolithography method.

### TECHNICAL FIELD

The present invention relates to a method for manufacturing a multilayer coil component and a multilayer coil component.

### BACKGROUND

The method described in, for example, Patent Literature 1 (Japanese Unexamined Patent Publication No. 2008-177365) is known as a method for manufacturing a multilayer coil component of the related art. The method for manufacturing the multilayer coil component described in Patent Literature 1 includes a first step of forming an unfired laminate formed by laminating an insulator layer and an internal electrode on a peelable base material by a photolithography method, a second step of cutting the laminate into a plurality of chips and then peeling off the base material to fire each chip, and a third step of forming an external electrode at both ends of the fired chips. In the third step, both end portions of the fired chips are dipped into conductive paste and baked and the external electrode is formed by plating on the baking layer.

### SUMMARY

When the external electrode is formed by a dipping method for element body (chip) immersion in conductive paste as in the manufacturing method of the related art, the thickness of the external electrode may become non-uniform. In the corner portions of the element body in particular, the external electrode becomes thinner than the other parts. The external electrode that is not uniform in thickness may result in a decline in yield or plating peeling attributable to a poor appearance.

One aspect of the present invention is to provide a method for manufacturing a multilayer coil component and a multilayer coil component allowing a terminal electrode to be uniform in thickness.

A method for manufacturing a multilayer coil component according to one aspect of the present invention includes: a step of forming an insulator layer; a step of forming a coil conductor; a step of obtaining a laminate formed by laminating the insulator layer and the coil conductor; and a step of forming a terminal electrode on an outer surface of the laminate by a photolithography method.

In the method for manufacturing a multilayer coil component according to one aspect of the present invention, the terminal electrode is formed on the outer surface of the laminate by a photolithography method. The terminal electrode can be formed with high accuracy by the photolithography method. Accordingly, the terminal electrode can be uniform in thickness by forming the terminal electrode by a photolithography method.

In one embodiment, the method may include: a step of forming a laminate substrate including a plurality of the laminates; and a step of turning the plurality of laminates into individual pieces from the laminate substrate, in which the terminal electrode may be formed on the individualized laminate in the step of forming the terminal electrode. In the method for cutting the terminal electrode into individual pieces after forming the terminal electrode, a large cutting stress is applied to the terminal electrode when the terminal electrode is cut by dicing. As a result, the terminal electrode may be deformed and the thickness of the terminal electrode may become non-uniform. In the method for manufacturing a multilayer coil component, the terminal electrode is formed on the individualized laminate, and thus deformation attributable to cutting can be avoided. Accordingly, the thickness of the terminal electrode can be uniform.

A multilayer coil component according to one aspect of the present invention includes: an element body formed by laminating a plurality of insulator layers; a coil disposed in the element body and configured to include a plurality of coil conductors; and a terminal electrode disposed on an outer surface of the element body and formed by a photolithography method, in which a relationship of (b/a)≥0.7 is satisfied in a case where a maximum thickness is a and a minimum thickness is b in the terminal electrode.

In the multilayer coil component according to one aspect of the present invention, the terminal electrode satisfies the above relationship. As a result, in the multilayer coil component, the thickness of the terminal electrode can be uniform.

In one embodiment, the multilayer coil component may include a bonded conductor disposed in the element body, exposed on the outer surface of the element body facing the terminal electrode, and bonded to the terminal electrode. In this configuration, the bonding strength between the element body and the terminal electrode can be improved.

In one embodiment, a plurality of the bonded conductors may be continuously provided. In this configuration, the bonding strength between the element body and the terminal electrode can be further increased.

In one embodiment, the element body may have a pair of end surfaces facing each other, a pair of main surfaces facing each other, and a pair of side surfaces facing each other as the outer surface and one of the main surfaces may be a mounting surface, the terminal electrode may have a first electrode part disposed on the end surface and a second electrode part disposed on the mounting surface and have an L shape when viewed from a facing direction of the pair of side surfaces, and a relationship of R1=R2≥R3 may be satisfied in a case where a curvature of a corner portion separated from the end surface at the first electrode part is R1, a curvature of a corner portion separated from the mounting surface at the second electrode part is R2, and a curvature of a corner portion formed by the first electrode part and the second electrode part is R3 when viewed from the facing direction. In this configuration, the thickness of the terminal electrode can be uniform since the relationship is satisfied.

According to one aspect of the present invention, the terminal electrode can be uniform in thickness.

### BRIEF DESCRIPTION OF THE DRAWINGS

FIG. 1 is a perspective view illustrating a multilayer coil component according to an embodiment.

FIG. 2 is a side view of the multilayer coil component of FIG. 1.

FIG. 3 is an exploded perspective view of an element body illustrated in FIG. 1.

FIG. 4 is a diagram illustrating a method for manufacturing the multilayer coil component.

FIG. 5 is a diagram illustrating the method for manufacturing the multilayer coil component.

FIG. 6 is a side view of a multilayer coil component according to another embodiment.

### DETAILED DESCRIPTION

Hereinafter, a preferred embodiment of the present invention will be described in detail with reference to the accompanying drawings. In the description of the drawings, the same or equivalent elements are denoted by the same reference numerals with redundant description omitted.

[Multilayer Coil Component]

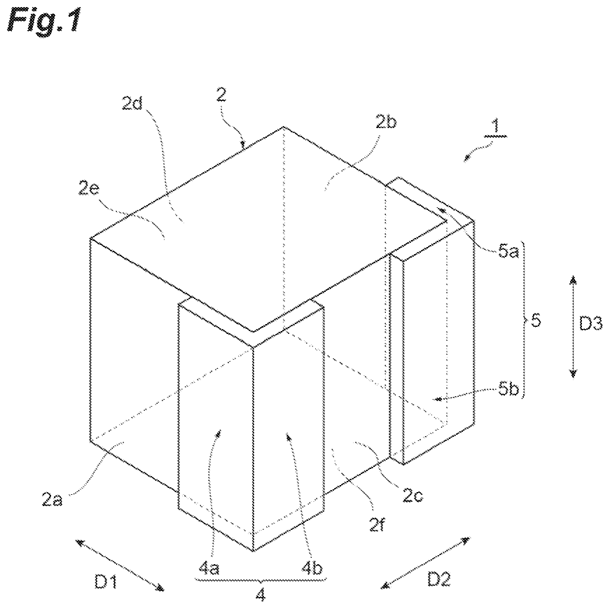

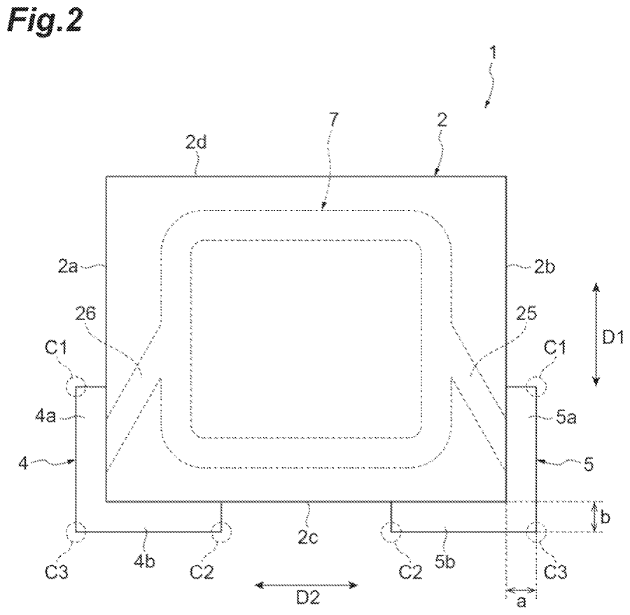

FIG. 1 is a perspective view of a multilayer coil component according to an embodiment. FIG. 2 is a side view of the multilayer coil component. As illustrated in FIGS. 1 and 2, a multilayer coil component 1 includes an element body 2 having a rectangular parallelepiped shape and a plurality (here, a pair) of terminal electrodes 4 and 5. The pair of terminal electrodes 4 and 5 are respectively disposed in both end portions of the element body 2. The rectangular parallelepiped shape includes a rectangular parallelepiped shape in which the corner and ridge portions are chamfered and a rectangular parallelepiped shape in which the corner and ridge portions are rounded.

The element body 2 has a pair of end surfaces 2a and 2b facing each other, a pair of main surfaces 2c and 2d facing each other, and a pair of side surfaces 2e and 2f facing each other as outer surfaces. In the following description, the facing direction in which the pair of main surfaces 2c and 2d face each other is a first direction D1, the facing direction in which the pair of end surfaces 2a and 2b face each other is a second direction D2, and the facing direction in which the pair of side surfaces 2e and 2f face each other is a third direction D3. In the present embodiment, the first direction D1 is the height direction of the element body 2. The second direction D2 is the length direction of the element body 2 and is orthogonal to the first direction D1. The third direction D3 is the width direction of the element body 2 and is orthogonal to the first direction D1 and the second direction D2.

The pair of end surfaces 2a and 2b extend in the first direction D1 so as to interconnect the pair of main surfaces 2c and 2d. The pair of end surfaces 2a and 2b also extend in the third direction D3, that is, the short side direction of the pair of main surfaces 2c and 2d. The pair of side surfaces 2e and 2f extend in the first direction D1 so as to interconnect the pair of main surfaces 2c and 2d. The pair of side surfaces 2e and 2f also extend in the second direction D2, that is, the long side direction of the pair of main surfaces 2c and 2d. The multilayer coil component 1 is, for example, solder-mounted on an electronic device (such as a circuit board and an electronic component). In the multilayer coil component 1, the main surface 2c constitutes a mounting surface facing the electronic device.

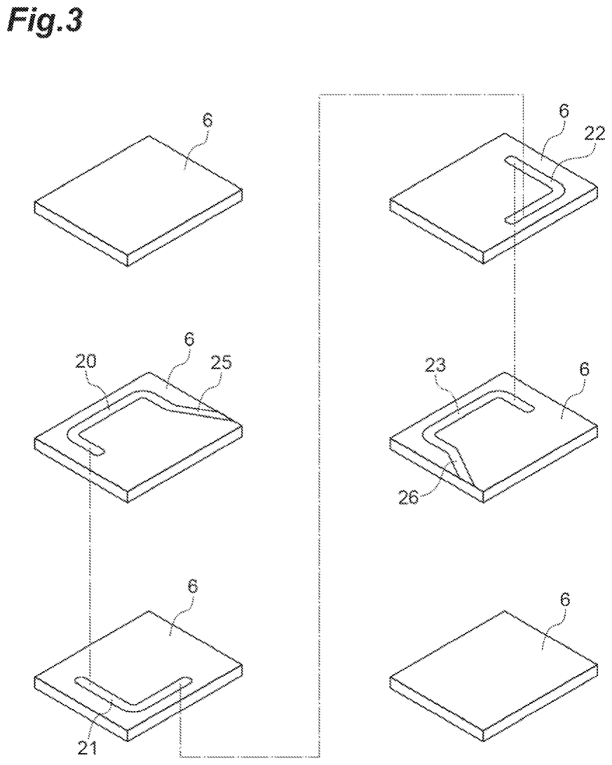

As illustrated in FIG. 3, the element body 2 is configured by laminating a plurality of element body layers 6 in the third direction D3. The element body 2 has the plurality of laminated element body layers 6. In the element body 2, the lamination direction in which the plurality of element body layers 6 are laminated coincides with the third direction D3. As will be described later, some of the element body layers 6 are formed integrally with the element body layers 6 adjacent in the lamination direction. In the actual element body 2, even the element body layers 6 formed as separate bodies are integrated to the extent that the boundaries between the element body layers 6 cannot be visually recognized.

Each element body layer 6 contains, for example, an insulating material. Each element body layer 6 contains, for example, a magnetic material as the insulating material. Examples of the magnetic material include a Ni—Cu—Zn-based ferrite material, a Ni—Cu—Zn—Mg-based ferrite material, a Ni—Cu-based ferrite material, and a Fe alloy. Each element body layer 6 may contain, for example, a non-magnetic material as the insulating material. Examples of the non-magnetic material include a glass ceramic material and a dielectric material. Each element body layer 6 may, for example, be formed through a firing step of firing an insulator layer containing an insulating material and include a sintered body of the insulating material.

As illustrated in FIG. 1, the pair of terminal electrodes 4 and 5 are separated from each other in the second direction D2. The terminal electrodes 4 and 5 have an L shape when viewed from the third direction D3. Each of the terminal electrodes 4 and 5 contains, for example, a conductive material. The conductive material contains, for example, Ag or Pd. The conductive material includes, for example, metal powder such as Ag powder and Pd powder. A plating layer may be formed on the surfaces of the terminal electrodes 4 and 5. The plating layer is formed by, for example, electroplating or electroless plating. The plating layer contains, for example, Ni, Sn, or Au.

The terminal electrode 4 is disposed on the end surface 2a side of the element body 2. The terminal electrode 4 is disposed over the end surface 2a and the main surface 2c. The terminal electrode 4 has a first electrode part 4a provided on the end surface 2a and a second electrode part 4b provided on the main surface 2c. The first electrode part 4a and the second electrode part 4b are provided integrally with each other. The first electrode part 4a and the second electrode part 4b are connected to each other in the ridge portion of the element body 2 and are electrically connected to each other.

The first electrode part 4a extends along the first direction D1. The first electrode part 4a has a rectangular shape when viewed from the second direction D2. The second electrode part 4b extends along the second direction D2. The second electrode part 4b has a rectangular shape when viewed from the first direction D1. The first electrode part 4a and the second electrode part 4b extend along the third direction D3.

The terminal electrode 5 is disposed on the end surface 2b side of the element body 2. The terminal electrode 5 is disposed over the end surface 2b and the main surface 2c. The terminal electrode 5 has a first electrode part 5a provided on the end surface 2b and a second electrode part 5b provided on the main surface 2c. The first electrode part 5a and the second electrode part 5b are provided integrally with each other. The first electrode part 5a and the second electrode part 5b are connected to each other at the ridge portion of the element body 2 and are electrically connected to each other.

The first electrode part 5a extends along the first direction D1. The first electrode part 5a has a rectangular shape when viewed from the second direction D2. The second electrode part 5b extends along the second direction D2. The second electrode part 5b has a rectangular shape when viewed from the first direction D1. The first electrode part 5a and the second electrode part 5b extend along the third direction D3.

The terminal electrodes 4 and 5 satisfy the following relationship in a case where the maximum thickness of the terminal electrodes 4 and 5 is a and the minimum thickness of the terminal electrodes 4 and 5 is b.

(b/a)≥0.7

The maximum thickness a and the minimum thickness b are the distances between the outer surface of the element body 2 (end surfaces 2a and 2b and main surface 2c) and the outer surfaces of the terminal electrodes 4 and 5 in the first direction D1 or the second direction D2. In FIG. 2, a indicates the thickness of the first electrode part 5a and b indicates the thickness of the second electrode part 5b for convenience. The maximum thickness a may be the first electrode parts 4a and 5a or the second electrode parts 4b and 5b. The minimum thickness b may be the first electrode parts 4a and 5a or the second electrode parts 4b and 5b.

In the terminal electrodes 4 and 5 that are viewed from the third direction D3, the following relationship is satisfied in a case where the curvature of a first corner portion C1 separated from the end surfaces 2a and 2b at the first electrode parts 4a and 5a is R1, the curvature of a second corner portion C2 separated from the main surface 2c at the second electrode parts 4b and 5b is R2, and the curvature of a third corner portion C3 formed by the first electrode parts 4a and 5a and the second electrode parts 4b and 5b is R3.

R1=R2≥R3

In other words, the curvature R1 and the curvature R2 are equal to each other and the curvature R1 and the curvature R2 are equal to or greater than the curvature R3. To be specific, the first corner portion C1 is positioned at the first electrode parts 4a and 5a, separated in the second direction D2 from the end surfaces 2a and 2b, and formed by a surface that is along the first direction D1 without being in contact with the end surfaces 2a and 2b and a surface that is positioned on the main surface 2d side and is along the second direction D2. To be specific, the second corner portion C2 is positioned at the second electrode parts 4b and 5b, separated in the first direction D1 from the main surface 2c, and formed by a surface that is along the second direction D2 without being in contact with the main surface 2c and a surface that is positioned on the end surface 2a or end surface 2b side and is along the first direction D1.

As illustrated in FIG. 2, the multilayer coil component 1 includes a coil 7 disposed in the element body 2. The coil axis of the coil 7 extends along the third direction D3. The coil 7 has a substantially rectangular outer shape when viewed from the third direction D3.

As illustrated in FIG. 3, the coil 7 (see FIG. 2) has a first coil conductor 20, a second coil conductor 21, a third coil conductor 22, and a fourth coil conductor 23. The first coil conductor 20, the second coil conductor 21, the third coil conductor 22, and the fourth coil conductor 23 are disposed in this order along the third direction D3. The first coil conductor 20, the second coil conductor 21, the third coil conductor 22, and the fourth coil conductor 23 have a substantially rectangular shape in which a part of a loop is interrupted and have one end and the other end. The first coil conductor 20, the second coil conductor 21, the third coil conductor 22, and the fourth coil conductor 23 have a part extending in a straight line along the first direction D1 and a part extending in a straight line along the second direction D2. The first coil conductor 20, the second coil conductor 21, the third coil conductor 22, and the fourth coil conductor 23 have a predetermined width.

The first coil conductor 20 is connected to the terminal electrode 5 via a connecting conductor 25. The connecting conductor 25 is positioned in the same layer as the first coil conductor 20. One end of the first coil conductor 20 is connected to the connecting conductor 25. The connecting conductor 25 connects the first coil conductor 20 and the first electrode part 5a of the terminal electrode 5. The connecting conductor 25 may be connected to the second electrode part 5b. The first coil conductor 20 and the connecting conductor 25 are integrally formed.

The second coil conductor 21 is connected to the first coil conductor 20. A part of the first coil conductor 20 and a part of the second coil conductor 21 overlap when viewed from the third direction D3. The third coil conductor 22 is connected to the second coil conductor 21. A part of the second coil conductor 21 and a part of the third coil conductor 22 overlap when viewed from the third direction D3.

The fourth coil conductor 23 is connected to the third coil conductor 22. A part of the third coil conductor 22 and a part of the fourth coil conductor 23 overlap when viewed from the third direction D3. The fourth coil conductor 23 is connected to the terminal electrode 4 via a connecting conductor 26. The connecting conductor 26 is positioned in the same layer as the fourth coil conductor 23. One end of the fourth coil conductor 23 is connected to the connecting conductor 26. The connecting conductor 26 connects the fourth coil conductor 23 and the first electrode part 4a of the terminal electrode 4. The connecting conductor 26 may be connected to the second electrode part 4b. The fourth coil conductor 23 and the connecting conductor 26 are integrally formed.

The first coil conductor 20, the second coil conductor 21, the third coil conductor 22, and the fourth coil conductor 23 constitute the coil 7 (see FIG. 2). The coil 7 is electrically connected to the terminal electrode 5 through the connecting conductor 25. The coil 7 is electrically connected to the terminal electrode 4 through the connecting conductor 26.

The first coil conductor 20, the second coil conductor 21, the third coil conductor 22, the fourth coil conductor 23, and the connecting conductors 25 and 26 contain a conductive material. The conductive material contains Ag or Pd. The conductive material includes, for example, metal powder such as Ag powder and Pd powder. In the present embodiment, the first coil conductor 20, the second coil conductor 21, the third coil conductor 22, the fourth coil conductor 23, and the connecting conductors 25 and 26 contain the same conductive material as the terminal electrodes 4 and 5. The first coil conductor 20, the second coil conductor 21, the third coil conductor 22, the fourth coil conductor 23, and the connecting conductors 25 and 26 may contain a conductive material different from the conductive material of the terminal electrodes 4 and 5. The first coil conductor 20, the second coil conductor 21, the third coil conductor 22, the fourth coil conductor 23, and the connecting conductors 25 and 26 are provided in the corresponding element body layers 6.

[Method for Manufacturing Multilayer Coil Component]

A method for manufacturing the multilayer coil component 1 will be described below. The method for manufacturing the multilayer coil component 1 includes a step of forming a laminate substrate 30, a step of turning a plurality of laminates L into individual pieces, and a step of forming the terminal electrodes 4 and 5.

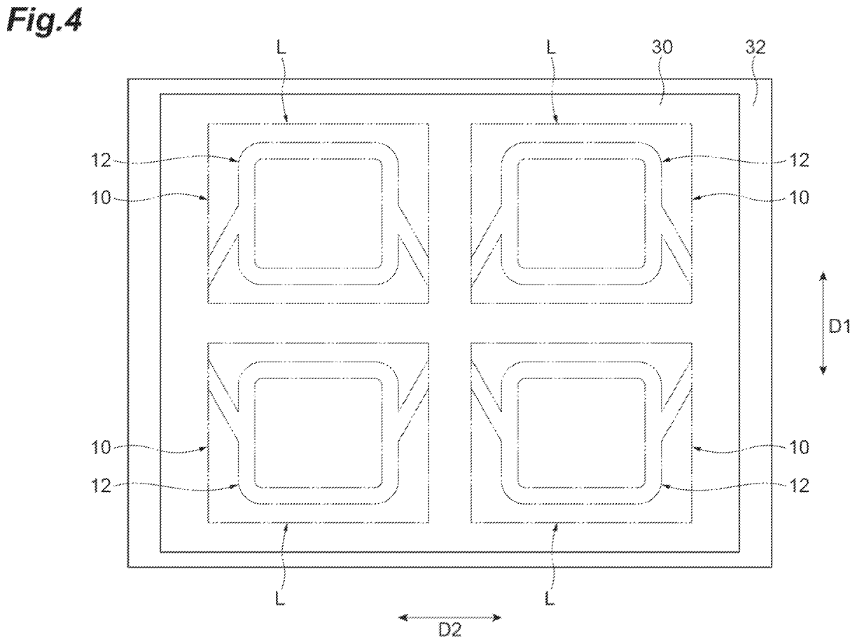

The step of forming the laminate substrate 30 will be described. In the step of forming the laminate substrate 30, the laminate substrate 30 is formed as illustrated in FIG. 4. The laminate substrate 30 is formed by laminating a plurality of insulator layers 10. The laminate substrate 30 includes the plurality of laminates L. The laminate L corresponds to the multilayer coil component 1. The laminate L may become the multilayer coil component 1 as it is without going through a firing step or may become the multilayer coil component 1 through a firing step.

“4” laminates L are used in the present embodiment. The laminate substrate 30 is formed on a base material 32. The plurality of laminates L are respectively arranged in the first direction D1 and the second direction D2 intersecting with the lamination direction when viewed from the lamination direction. The plurality of laminates L are formed integrally with the part that is removed during the individualization (cut portion, divided portion).

The laminate L has a conductor 12 corresponding to the first coil conductor 20, the second coil conductor 21, the third coil conductor 22, the fourth coil conductor 23, and the connecting conductors 25 and 26 and the insulator layer 10 corresponding to the element body layer 6. The conductor 12 may become the first coil conductor 20, the second coil conductor 21, the third coil conductor 22, the fourth coil conductor 23, and the connecting conductors 25 and 26 as it is without going through a firing step or may become the first coil conductor 20, the second coil conductor 21, the third coil conductor 22, the fourth coil conductor 23, and the connecting conductors 25 and 26 through a firing step. The insulator layer 10 may become the element body layer 6 as it is without going through a firing step or may become the element body layer 6 through a firing step.

In the present embodiment, the laminate substrate 30 is manufactured by a photolithography method. The “photolithography method” of the present embodiment may be any by which a layer that contains a photosensitive material and is to be processed is processed into a desired pattern by exposure and development and is not limited to mask types and so on.

First, one layer of the insulator layer 10 is formed by applying an insulating material onto the base material 32. Subsequently, the conductor 12 corresponding to the first coil conductor 20 and the connecting conductor 25 is formed on the insulator layer 10. The conductor 12 is formed by a photolithography method. Specifically, photosensitive silver paste (photosensitive conductive paste) is applied onto the insulator layer 10. Subsequently, the photosensitive silver paste is exposed by being irradiated with ultraviolet rays via a mask (such as a Cr mask) having the pattern of the conductor 12 and developed with a developing solution. The conductor 12 is formed as a result.

Subsequently, one layer of the insulator layer 10 is formed. The insulator layer 10 is formed around the conductor 12. The insulator layer 10 is formed by a photolithography method. Specifically, photosensitive insulator paste is applied onto the insulator layer 10 and the conductor 12, that is, such that the entire area of the conductor 12 is covered. Subsequently, the photosensitive insulator paste is exposed by being irradiated with ultraviolet rays via a mask having the pattern of the conductor 12 and developed with a developing solution. The insulator layer 10 is formed as a result.

The laminate substrate 30 is formed by forming the conductor 12 and the plurality of insulator layers 10 corresponding to the second coil conductor 21, the third coil conductor 22, the fourth coil conductor 23, and the connecting conductor 26 by the above method.

Next, the step of turning the plurality of laminates L into individual pieces will be described. In the step of individualizing the plurality of laminates L, the laminate L is individualized by, for example, dicing. Specifically, the laminate substrate 30 is cut along the first direction D1 and the second direction D2. A dicing blade passes at least between the laminates L that are adjacent to each other in the first direction D1 and between the laminates L that are adjacent to each other in the second direction D2. As a result, the laminate substrate 30 is divided and the plurality of laminates L become individual pieces. On the base material 32, a groove is formed between the adjacent laminates L as a result of the division of the laminate substrate 30. It should be noted that the individualization of the laminate L may be performed by another method. For example, the laminate substrate 30 may be laser-cut or a part other than the laminate L may be removed by a photolithography method.

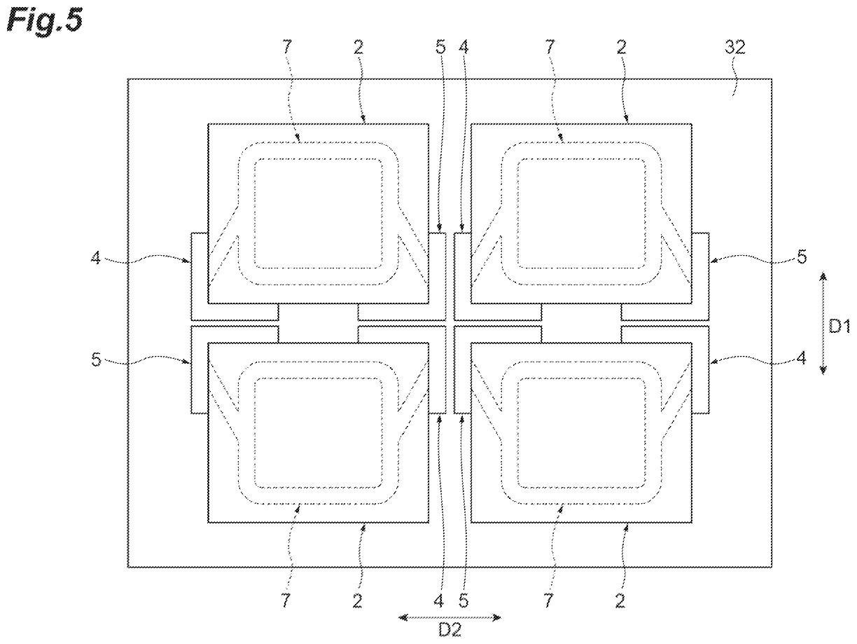

Next, the step of forming the terminal electrodes 4 and 5 will be described. The terminal electrodes 4 and 5 are formed by a photolithography method. In the step of forming the terminal electrodes 4 and 5, photosensitive silver paste is applied to the groove between the individualized laminates L (photosensitive silver paste filling is performed on the base material 32). Subsequently, the photosensitive silver paste is exposed by being irradiated with ultraviolet rays via a mask having the pattern of the terminal electrodes 4 and 5 and developed with a developing solution. As a result, the terminal electrodes 4 and 5 are formed as illustrated in FIG. 5. The laminate L where the terminal electrodes 4 and 5 are formed may become the multilayer coil component 1 as it is without going through a firing step or may become the multilayer coil component 1 through a firing step as described above. If necessary, a plating layer may be provided by performing electrolytic plating or electroless plating on the terminal electrodes 4 and 5.

As described above, in the method for manufacturing the multilayer coil component 1 according to the present embodiment, the terminal electrodes 4 and 5 are formed on the outer surface of the laminate L by a photolithography method. The terminal electrodes 4 and 5 can be formed with high accuracy by the photolithography method. As a result, the terminal electrodes 4 and 5 that have desired dimensions can be formed. Accordingly, the terminal electrodes 4 and 5 can be uniform in thickness by forming the terminal electrodes 4 and 5 by a photolithography method. As a result, it is possible to avoid a decline in yield or plating peeling attributable to a poor appearance.

In addition, in the method for manufacturing the multilayer coil component 1, the thickness of the terminal electrode 4 and the thickness of the terminal electrode 5 can be uniformly reduced by forming the terminal electrodes 4 and 5 by a photolithography method. As a result, the stray capacitance formed between the terminal electrodes 4 and 5 and the coil 7 can be reduced. As a result, self-resonant frequency (SRF) characteristics can be improved (the self-resonant frequency can be set to the high frequency side).

The method for manufacturing the multilayer coil component 1 according to the present embodiment includes the step of forming the laminate substrate 30 including the plurality of laminates L and the step of individualizing the plurality of laminates L from the laminate substrate 30. In the step of forming the terminal electrodes 4 and 5, the terminal electrodes 4 and 5 are formed on the individualized laminate L. In the method for cutting the terminal electrode into individual pieces after forming the terminal electrode, a large cutting stress is applied to the terminal electrode when the terminal electrode is cut by dicing. As a result, the terminal electrode may be deformed and the thickness of the terminal electrode may become non-uniform. In the method for manufacturing the multilayer coil component 1, the terminal electrodes 4 and 5 are formed on the individualized laminate L, and thus deformation attributable to cutting can be avoided. Accordingly, the thickness of the terminal electrode 4 and the thickness of the terminal electrode 5 can be uniform.

In the multilayer coil component 1 according to the present embodiment, the relationship of (b/a)≥0.7 is satisfied in a case where a and b are the maximum thickness and the minimum thickness in the terminal electrodes 4 and 5, respectively. As a result, in the multilayer coil component 1, the thickness of the terminal electrode 4 and the thickness of the terminal electrode 5 can be uniform.

In the multilayer coil component 1 according to the present embodiment, the terminal electrodes 4 and 5 have the first electrode parts 4a and 5a disposed on the end surfaces 2a and 2b and the second electrode parts 4b and 5b disposed on the main surface 2c and have an L shape when viewed from the third direction D3. In the multilayer coil component 1 that is viewed from the third direction D3, the relationship of R1=R2≥R3 is satisfied in a case where the curvature of the first corner portion C1 separated from the end surfaces 2a and 2b at the first electrode parts 4a and 5a is R1, the curvature of the second corner portion C2 separated from the main surface 2c at the second electrode parts 4b and 5b is R2, and the curvature of the third corner portion C3 formed by the first electrode parts 4a and 5a and the second electrode parts 4b and 5b is R3. In this configuration, the thickness of the terminal electrode 4 and the thickness of the terminal electrode 5 can be uniform since the relationship is satisfied.

The present invention is not necessarily limited to the embodiment of the present invention described above, and various modifications can be made within the gist thereof.

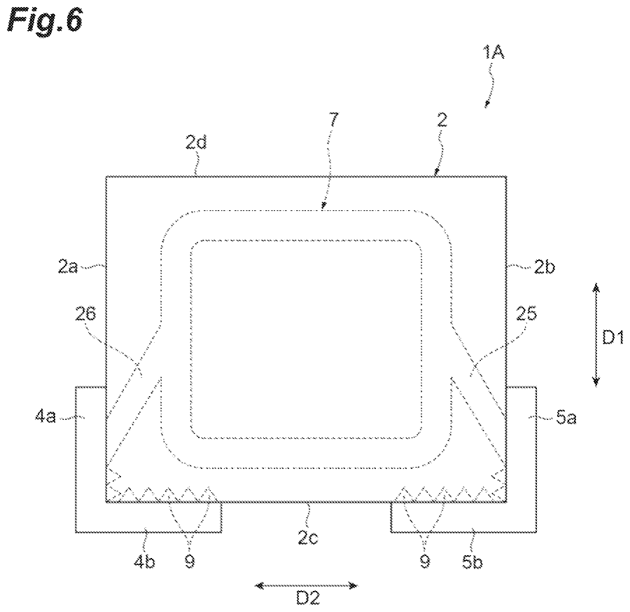

In addition to the above embodiment, a multilayer coil component 1A may include a bonded conductor 9 as illustrated in FIG. 6. The bonded conductor 9 is disposed in the element body 2 and exposed on the outer surface of the element body 2 that faces the terminal electrodes 4 and 5. In the example illustrated in FIG. 6, the bonded conductor 9 is exposed on the end surfaces 2a and 2b and the main surface 2c. The bonded conductor 9 is bonded (fixed) to the terminal electrodes 4 and 5. The bonded conductor 9 contains a conductive material. The conductive material contains Ag or Pd. The conductive material includes, for example, metal powder such as Ag powder and Pd powder.

The bonded conductor 9 has, for example, a triangular shape when viewed from the third direction D3. The shape of the bonded conductor 9 may be a rectangular shape, a semicircular shape, or the like. The bonded conductor 9 can be formed at the same time as the coil conductor. Specifically, the bonded conductor 9 can be formed using a mask having a pattern corresponding to the coil conductor and the bonded conductor 9.

The bonded conductor 9 is continuously provided (side by side) in the first direction D1 and continuously provided in the second direction D2. The bonded conductor 9 may be provided independently or a plurality of the bonded conductors 9 may be integrally provided (connected). The bonded conductors 9 may have the same size without exception or may have different sizes. The bonded conductor 9 may extend along the third direction D3 or be disposed intermittently (at intervals) in the third direction D3.

The multilayer coil component 1A includes the bonded conductor 9, and thus the bonding strength between the element body 2 and the terminal electrodes 4 and 5 can be improved. In addition, the bonding strength can be further increased by continuously providing a plurality of the bonded conductors 9.

In the above embodiment, a form in which the terminal electrodes 4 and 5 include the first electrode parts 4a and 5a and the second electrode parts 4b and 5b has been described as an example. However, the configuration of the terminal electrodes 4 and 5 is not limited thereto. For example, the terminal electrodes 4 and 5 may have the second electrode parts 4b and 5b without having the first electrode parts 4a and 5a.

In the above embodiment, a form in which the terminal electrodes 4 and 5 are disposed on the end surfaces 2a and 2b and the main surface 2c of the element body 2 has been described as an example. Alternatively, the terminal electrodes 4 and 5 may be partially embedded in the element body 2. For example, recess portions may be formed in the end surfaces 2a and 2b and the main surface 2c of the element body 2 and a part of the terminal electrode 4 and a part of the terminal electrode 5 may be provided in the recess portions. In this case, the outer surface of the element body 2 means the surface that forms the recess portion.

In the above embodiment, a form in which the coil 7 is configured by the first coil conductor 20, the second coil conductor 21, the third coil conductor 22, and the fourth coil conductor 23 has been described as an example. However, the number of coil conductors constituting the coil 7 is not limited to the above value.

In the above embodiment, a form in which the laminate L is obtained by forming the laminate substrate 30 and individualizing the laminate L from the laminate substrate 30 has been described as an example. Alternatively, the terminal electrodes 4 and 5 may be formed on one laminate L with the laminate L formed.

In the above embodiment, a form in which the laminate substrate 30 is formed by a photolithography method has been described as an example. The laminate substrate 30 may be formed by another method. For example, the laminate substrate 30 may be formed by laminating an insulator layer where a coil conductor is formed.

What is claimed is:

1. A method for manufacturing a multilayer coil component comprising:
a step of forming an insulator layer;
a step of forming a coil conductor;
a step of obtaining a laminate formed by laminating the insulator layer and the coil conductor; and
a step of forming a terminal electrode on an outer surface of the laminate by a photolithography method.

2. The method for manufacturing a multilayer coil component according to claim 1, comprising:
a step of forming a laminate substrate including a plurality of the laminates; and
a step of turning the plurality of laminates into individual pieces from the laminate substrate,
wherein the terminal electrode is formed on the individualized laminate in the step of forming the terminal electrode.

3. A multilayer coil component comprising:
an element body formed by laminating a plurality of insulator layers;
a coil disposed in the element body and configured by a plurality of coil conductors; and
a terminal electrode disposed on an outer surface of the element body and formed by a photolithography method,
wherein a relationship of (b/a)≥0.7 is satisfied in a case where a maximum thickness is a and a minimum thickness is b in the terminal electrode.

4. The multilayer coil component according to claim 3, comprising a bonded conductor disposed in the element body, exposed on the outer surface of the element body facing the terminal electrode, and bonded to the terminal electrode.

5. The multilayer coil component according to claim 4, wherein a plurality of the bonded conductors are continuously provided.

6. The multilayer coil component according to claim 3, wherein
the element body has a pair of end surfaces facing each other, a pair of main surfaces facing each other, and a pair of side surfaces facing each other as the outer surface and one of the main surfaces is a mounting surface,
the terminal electrode has a first electrode part disposed on the end surface and a second electrode part disposed on the mounting surface and has an L shape when viewed from a facing direction of the pair of side surfaces, and
a relationship of R1=R2≥R3 is satisfied in a case where a curvature of a corner portion separated from the end surface at the first electrode part is R1, a curvature of a corner portion separated from the mounting surface at the second electrode part is R2, and a curvature of a corner portion formed by the first electrode part and the second electrode part is R3 when viewed from the facing direction.
